(19) United States
(12) Patent Application Publication
(10) Pub. No.: US 2002/0028876 A1
(43) Pub. Date: Mar. 7, 2002

(54) Carpet backing compositions containing nonionic siloxane alkoxylate/organic cosurfactant blends as frothing aids and their use in production of carpets

(76) Inventors: Randall C. Jenkines, Dalton, GA (US); Richard M. Gerkin, Cross Lanes, WV (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/952,177

(22) Filed: Sep. 13, 2001

Related U.S. Application Data
(63) Continuation of application No. 09/434,822, filed on Nov. 5, 1999, now abandoned.

(51) Int. Cl. C08K 5/24; C08K 3/20

(52) U.S. Cl. 524/591; 524/261

(57) ABSTRACT

A frothing aid for preparing coatings, adhesives, and sealants as well as for preparing a polyurethane-backed carpet is provided. The frothing aid comprises a blend of a nonionic siloxane alkoxylate and an organic cosurfactant. In particular, an aqueous polyurethane dispersion comprising a polyurethane dispersion composition and the frothing aid is provided. Moreover, a method for applying the aqueous polyurethane dispersion to a substrate is provided.

### FIELD OF THE INVENTION

This invention relates to coatings, adhesives, and sealants as well as polyurethane-backed carpets. More particularly, it relates to aqueous polyurethane dispersions containing a nonionic siloxane alkoxylate/organic cosurfactant blend as a frothing aid and a method for applying the polyurethane dispersion to a substrate.

### DESCRIPTION OF THE PRIOR ART

Generally, tufted carpets minimally consist of tufted fibers through a primary backing and a precoat. Tufted carpets may also have additional layers such as a laminate layer, a secondary layer, and a foam layer. Moreover, the tufted carpet may have more than one secondary layer.

The precoat is required to anchor the carpet tufts to the primary backing. It may also contain an adhesive to adhere the tufted carpet to additional layers or the subfloor. The precoat can affect the carpet's tuft bind, hand, delaminating properties, wet strength properties, wear resistance, and barrier performance. Alternatively, a laminate layer may be applied without a precoat. However, better anchoring is achieved when a precoat is also applied than when a laminate layer is applied alone.

Precoat, laminate, and foam layers may be prepared from several materials. They may be prepared from a butadiene-acrylonitrile latex, an ethylene-vinyl acetate latex, a styrene-butadiene-butyl acrylate latex, a chloroprene latex, a polyethylene copolymer latex, an ethylene-styrene latex, a styrene-butadiene-vinylidene chloride latex, a styrene-alkyl acrylate latex, a vinyl latex, or an acrylic latex. However, they are usually prepared from a polyurethane material or a styrene-butadiene latex.

With regard to polyurethane layers, conventional practice in the carpet manufacturing industry requires that a polyurethane layer be prepared from an isocyanate formulation (A-side formulation) and a polyol formulation (B-side formulation) at the carpet manufacturing site. This is sometimes referred to as “A+B chemistry”. Preparing a polyurethane layer by A+B chemistry can result in unpredictable loss of production and inefficiency due to problems that can occur in carrying out the reaction at the manufacturing site, such as premature gellation.

Alternatively, the polyurethane layer may be applied as an aqueous polyurethane (PU) dispersion. Aqueous PU dispersions can be prepared by polymerizing the polyurethane reactants in an organic solvent followed by dispersion of the resulting solution in water, and optionally followed by removal of organic solvent. See U.S. Pat. Nos. 3,437,624; 4,092,286; 4,237,264; 4,742,095; 4,857,565; 4,879,322; 5,037,864; and 5,221,710, which are incorporated herein by reference. Also, an aqueous polyurethane dispersion may be prepared by first forming a prepolymer, next dispersing the prepolymer in water, and finally conducting a chain extension in the water as disclosed in WO 98/41552, published Sep. 24, 1998, which is incorporated herein by reference. In this instance, the aqueous polyurethane dispersion will preferably have water as a continuous phase. U.S. Pat. No. 4,296,159 to Jenkines, et al., discloses preparing a tufted or woven article having a unitary backing prepared by applying a polyurethane forming composition to the underside of the tufted or woven article.

As a polyurethane dispersion, the polyurethane layer may be applied as a blown formulation. The blown formulation is generally prepared by mixing the A-side components with the B-side components in the presence of a gas, which is either mechanically introduced or chemically produced, to form bubbles that yield a cell-like structure in the cured polyurethane. Mechanical whipping of gas into a polyurethane formulation is also termed “frothing.”

As the quantity of gas is increased, the density of the resultant polyurethane layer is reduced. Blowing the formulation can reduce the coating weight of the polyurethane layer and facilitate a more uniform application of the polyurethane layer. Because the cost of the polyurethane layer is directly related to the coating weight, coating weight reductions also reduce cost.

To facilitate coating weight reduction in frothed styrene-butadiene latex carpet compounds, water-based anionic soaps are often used. Examples include sodium lauryl sulfate, ammonium lauryl sulfate, disodium N-octadecylsulfosuccinimate, and the like. Unfortunately, when these materials are compounded into low load styrene-butadiene latexes or low load aqueous polyurethane dispersions, detrimental consequences arise. Solid levels are reduced, thereby slowing coater speed. Thickener demand is increased, which in turn, raises formulation costs. Unsightly blistering can occur and hinder installation. Additionally, the layer's cellular nature can increase such that it diminishes physical properties such as tuft bind, edge ravel, and delamination strength.

There is a need to provide a surfactant that facilitates frothing of low load styrene-butadiene latexes or low load aqueous polyurethane dispersions without detrimentally affecting the polymer's performance. Also, it would be desirable to provide a surfactant, which can be used at low levels, to lower costs.

### SUMMARY OF THE INVENTION

According to the present invention, a frothing aid for preparing coatings, adhesives, and sealants as well as for preparing a polyurethane-backed carpet is provided. The frothing aid comprises a blend of a nonionic siloxane alkoxylate and an organic cosurfactant. In particular, an aqueous polyurethane dispersion comprising a polyurethane dispersion composition and the frothing aid is provided. Moreover, a method for applying the aqueous polyurethane dispersion to a substrate is provided.

A frothing aid of the present invention is a blend of (A) a nonionic siloxane alkoxylate having the formula: R¹Me₂SiO[Me₂SiO]_{f}[MeSi(Q)O]_{g}SiMe₂R¹ wherein f=0 to 1; g=1 to 2; Q=C_{d}H_{2d}O(C₂H₄O)ₜ(C₃H₆O)_{W}(C₄H_{X}R² wherein d=2 to 4; t=3 to 12; w=0 to 8; x=0 to 8, providing when w or x>0, (t+w+x)=5 to 12; ) R² is hydrogen, acetyl, or a hydrocarbon radical having 1 to 4 carbon atoms; and R¹ is Q or an alkyl having 1 to 4 carbon atoms; and (B) an organic cosurfactant having the formula: R³O(C₂H₄O)ₐ(C₃H₆O)_{b}(C₄H₈O)_{c}R⁴ wherein R³ is an alkyl, alkenyl, aryl, or alkaryl having 8 to 16 carbon atoms; a=2 to 12; b=0 to 2; c=0 to 2; and R⁴ is hydrogen, acetyl, or a hydrocarbon radical having 1 to 4 carbon atoms. “Me” represents a methyl group. The molar ratio for the nonionic siloxane alkoxylate to the organic cosurfactant should be between 1:19 to 19:1.

### DESCRIPTION OF THE INVENTION

In the preferred embodiment of the present invention, the aqueous polyurethane dispersion comprises a polyurethane dispersion composition and the frothing aid. The present invention is useful for preparing a coating, an adhesive, or a sealant as well as for preparing a polyurethane-backed carpet.

In the present invention, polyurethane can refer to a polyurethane compound, a polyurea compound, or mixtures thereof. A polyurethane compound can be obtained by the reaction of a polyol with a polyisocyanate. A polyurea compound can be obtained by the reaction of an amine with a polyisocyanate. A polyurethane compound or polyurea compound can contain both urea and urethane functionality, depending on what compounds are included in the A and/or B-side formulations. For the purposes of the present application, no further distinction will be made herein between the polyurethane compounds and polyurea compounds. The term “polyurethane” will be used generically to describe a polyurethane compound, a polyurea compound, and mixtures thereof.

A polyurethane dispersion composition useful in the practice of the present invention includes water, and a polymeric compound selected from the group consisting of a polyurethane compound. a mixture of polyurethane-forming compounds, and mixtures thereof. Preferably, the aqueous polyurethane dispersion will have water as a continuous phase. Polyurethane-forming compounds as used in the present invention are compounds that are capable of forming polyurethane polymers. Polyurethane-forming compounds include, for example, polyurethane prepolymers. Prepolymers useful in the practice of the present invention are prepared by the reaction of active hydrogen compounds with any amount of isocyanate in excess material relative to active hydrogen material. The isocyanate functionality can be present in an amount of from about 0.2 wt% to about 40 wt%. A suitable prepolymer can have a molecular weight in the range of from about 100 to about 10,000. Prepolymers useful in the practice of the present invention should be substantially liquid under the conditions of dispersion.

Active hydrogen compounds can be described as compounds having functional groups that contain at least one hydrogen atom bonded directly to an electronegative atom such as nitrogen, oxygen or sulfur. Suitable active hydrogen compounds can be polyols of molecular weight of less than about 6000.

A frothing aid of the present invention is a blend of (A) a nonionic siloxane alkoxylate having the formula

R¹Me₂SiO[Me₂SiO]_{f}[MeSi(Q)O]_{g}SiMe₂R¹

wherein f=0 to 1; g=1 to 2; Q=C_{d}H_{2d}O(C₂H₄O)ₜ (C₃H₆O)_{W}(C₄H₈O)_{X}R²wherein d=2 to 4; t=3 to 12; w=0 to 8; x=0 to 8, providing when w or x>0, (t+w+x) =5 to 12; R² is hydrogen, acetyl, or a hydrocarbon radical having 1 to 4 carbon atoms; and R¹ is Q or an alkyl having 1 to 4 carbon atoms; and (B) an organic cosurfactant having the formula

R³O(C₂ H₄O)ₐ(C₃H₆O)_{b}(C₄H₈O)_{c}R⁴

wherein R³ is an alkyl, alkenyl, aryl, or alkaryl having 8 to 16 carbon atoms; a=2 to 12; b=0 to 2; c=0 to 2; and R⁴ is hydrogen, acetyl, or a hydrocarbon radical having 1 to 4 carbon atoms. “Me” represents a methyl group.

Preferably, f=0, g=1, d=3, t=4 to 8, R¹ is methyl, R³ is alkyl having 8 to 12 carbon atoms, R²is H or Me, R⁴is H, w=0, x=0, a=5 to 8, b=0, and c=0. More preferably, t=7 to 8, R³ is alkyl having 10 to 12 carbon atoms, and a=5.

The alkylene oxides of Q and the organic cosurfactant can be random or blocked.

The molar ratio for the nonionic siloxane alkoxylate to the organic cosurfactant should be between 1:19 to 19:1. Preferably, the molar ratio is between 5:1 to 1:5. More preferably, the molar ratio is between 0.8:1 to 1.2:1.

Examples of the nonionic siloxane alkoxylate are available commercially from CK Witco Corporation under the trademark SILWET™. Examples of the organic surfactants are available commercially from CK Witco Corporation under the trademark WITCONOL™ and from Union Carbide Corporation under the trademarks TERGITOL™ and TRITON™.

A polyurethane dispersion as described herein can include chain extenders, catalysts, fillers. filler wetting agents, surfactants, blowing agents, frothing agents. dispersants, foam stabilizers, thickeners, fire retardants, defoamers, pigments, antistatic agents, reinforcing fibers, antioxidants, preservatives. acid scavengers, and other materials useful in polyurethane formulations. A chain extender is used herein to build the molecular weight of the polyurethane prepolymer by reaction of the chain extender with the isocyanate functionality in the polyurethane prepolymer, i.e., chain extend the polyurethane prepolymer.

A suitable chain extender is typically a low equivalent weight active hydrogen containing compound, having about 2 or more active hydrogen groups per molecule. The active hydrogen groups can be hydroxyl, mercaptyl, or amino groups. An amine chain extender can be blocked, encapsulated, or otherwise rendered less reactive. Other materials. particularly water, can function to extend chain length and so are chain extenders for purposes of the present invention. Polyamines are preferred chain extenders. It is particularly preferred that the chain extender be selected from the group consisting of amine terminated polyethers such as, for example, JEFFAMINE D-400™ from Huntsman Chemical Company, amino ethyl piperazine, 2-methyl piperazine, 1,5-diamino-3-methyl-pentane, isophorone diamine, ethylene diamine, diethylene triamine, triethylene tetramine, tetraethylene pentamine, ethanolamine, lysine in any of its stereoisomeric forms and salts thereof, hexane diamine, hydrazine and piperazine. In the practice of the present invention, the chain extender is often used as a solution of chain extender in water.

Small amounts of chain extender can be advantageously used. Generally, the chain extender is employed at a level sufficient to react with from about zero (0) to about 100 percent of the isocyanate functionality present in the prepolymer, based on one equivalent of isocyanate reacting with one equivalent of chain extender. It can be desirable, under certain conditions, to allow water to act as a chain extender and react with some or all of the isocyanate functionality present.

A catalyst can be used to promote the reaction between a chain extender and an isocyanate. Suitable catalysts include tertiary amines, organometallic compounds, similar compounds, and mixtures thereof. For example, suitable catalysts include di-n-butyl tin bis(mercaptoacetic acid isooctyl ester), dimethyltin dilaurate, dibutyltin dilaurate, dibutyltin sulfide, stannous octoate, lead octoate, ferric acetylacetonate, bismuth carboxylates. triethylenediamine, N-methyl morpholine, similar compounds, and mixtures thereof. An amount of catalyst is advantageously employed such that a relatively rapid cure to a tack-free state can be obtained. If an organometallic catalyst is employed, such a cure can be obtained by using from about 0.01 to about 0.5 parts per 100 parts of the polyurethane-forming composition, by weight. If a tertiary amine catalyst is employed, the catalyst preferably provides a suitable cure using from about 0.01 to about 3 parts of tertiary amine catalyst per 100 parts of the polyurethane-forming composition, by weight. Both an amine type catalyst and an organometallic catalyst can be employed in combination.

The present invention can include conventional fillers such as milled glass, calcium carbonate, aluminum trihydrate, talc, bentonite, antimony trioxide, kaolin, fly ash, or other known fillers. A suitable filler loading in a polyurethane dispersion can be from about 100 to about 1000 parts of filler per 100 parts of the polyurethane compound. Preferably, the filler material can be loaded in an amount of at least about 200 pph (phr), more preferably at least about 300 pph, most preferably at least about 400 pph.

The present invention can include a filler wetting agent. A filler wetting agent generally renders the filler material compatible with a polyurethane-forming composition. Useful wetting agents include phosphate salts such as sodium hexametaphosphate. A filler wetting agent can be included in a polyurethane-forming composition of the present invention at a concentration of at least about 0.1 parts per 100 parts of filler, by weight.

Useful surfactants to make an aqueous polyurethane dispersion include cationic and anionic surfactants. Examples of anionic surfactants include sulfonates, carboxylates, and phosphates. Examples of cationic surfactants include quaternary amines. Surfactants can be either external or internal. External surfactants are surfactants are not chemically reacted into the polymer during dispersion preparation. Internal surfactants are chemically reacted into the polymer during dispersion preparation. A surfactant can be included in an amount ranging from about 0.01 to about 20 parts per 100 parts by weight of polyurethane component.

Examples of suitable blowing agents are gases such as air, carbon dioxide, nitrogen, argon, and helium; liquids such as water, low molecular weight hydrocarbons, and volatile halogenated alkanes; and azo-blowing agents such as azobis(formamide). Volatile halogenated alkanes include the various chlorofluoromethanes and chlorofluoroethanes. Preferable is the use of air as a blowing or frothing agent. A frothing agent can differ from a blowing agent in that frothing agents are typically introduced by mechanical whipping into the polyurethane formulation.

A polyurethane dispersion of the present invention can be stored for later application to a surface. Storage for this purpose requires that the dispersion be storage-stable. Alternatively, the polyurethane dispersion can be applied in a continuous manner to the surface. That is, the dispersion can be applied to the surface as the dispersion is obtained. Polyurethane dispersions applied in a continuous manner are not required to be storage-stable, and can have higher solids content and/or larger mean particle size than typical storage-stable polyurethane dispersion formulations.

A suitable storage-stable polyurethane dispersion as defined herein is any polyurethane dispersion having a mean particle size of less than about 5 micrometers; a more preferable mean particle size is less than about 1 micrometer. A polyurethane dispersion that is not storage-stable can have a mean particle size of greater than 5 micrometers. For example, a suitable dispersion can be prepared by mixing a polyurethane prepolymer with water and dispersing the prepolymer in the water using a commercial blender. Alternatively, a suitable dispersion can be prepared by feeding a prepolymer into a static mixing device along with water, and dispersing the water and prepolymer in the static mixer. Continuous methods for preparing aqueous dispersions of polyurethane are known and can be used in the practice of the present invention. For example, U.S. Pat. Nos. 3,437,624; 4,092,286; 4,237,264; 4,742,095: 4,857,565; 4,879,322; 5,037,864; and 5,221,710 describe continuous processes useful for obtaining aqueous polyurethane dispersions. In addition, a continuous process for preparing an aqueous polyurethane dispersion having a high internal phase ratio is described in U.S. Pat. No. 5,539,021, incorporated herein by reference.

In preparing a frothed aqueous polyurethane dispersion, it is often preferable to premix all of the components except the polyisocyanate (and the blowing agent when a gas is used) to form a “B” component. The polyisocyanate and the B component are admixed and then the blowing agent gas is blended in using, for example, an OAKES FROTHER* (a trade designation of the E.T. Oakes Corporation). The composition is preferably applied to a textile or other substrate prior to any significant level of curing using equipment such as a doctor knife, air knife, or extruder to apply and gauge the layer. In the alternative, the composition may be applied by (1) forming it into a layer on a moving belt or other suitable apparatus, (2) dehydrating or partially curing, and (3) finally, marrying it to the substrate. It may be married with equipment such as a double belt laminator (also known as double band) or a moving belt with an applied foam cushion. The polyurethane is then allowed to cure by applying heat by means of an infrared oven, open flame forced draft convection impingement oven, heated plates or the like.

Suitable substrates include paper (e.g., release paper), metal foils, polymeric sheets (e.g., polyethylene terephthalate), wood, nonwoven fabric, rubber, and textiles. The preferred substrate is carpet.

In preparing polyurethane-backed carpets according to the present invention, an aqueous polyurethane dispersion is applied as a layer of preferably uniform thickness onto one surface of a carpet primary backing. Aqueous polyurethane dispersions of the present invention can be applied as a precoat, a laminate layer, or a foam layer. Polyurethane precoats, laminate layers, and foam layers can be prepared by methods known in the art. Precoats, laminate layers and foam layers prepared from latexes are described in P. L. Fitzgerald, “Integral Latex Foam Carpet Cushioning”, J. Coat. Fab. 1977, Vol. 7 (pp.107-120), and in R. P. Brentin, “Latex Coating Systems for Carpet Backing”, J. Coat. Fab. 1982, Vol. 12 (pp. 82 -91).

The polyurethane-forming composition can be applied to a substrate before it cures to a tack-free state. Alternatively, a polyurethane dispersion containing no unreacted isocyanate functionality can be applied. thereby removing the need to cure the polymer.

When the substrate is carpet, the polyurethane-forming composition is typically applied to the carpet surface attached to a primary backing. The amount of polyurethane-forming composition used can vary widely, from about 5 to about 500 ounces per square yard (0.17 to 16.95 kg/sq. meter), depending on the characteristics of the textile.

The embodiments described herein are given to illustrate the scope and spirit of the present invention. The embodiments herein will make apparent to those skilled in the art other embodiments that may also be used. These other embodiments are within the scope of the present invention. Thus, the scope of the invention should be determined by the appended claims and their legal equivalents, rather than by the embodiments given herein.

### EXAMPLES

The following examples merely exemplify various embodiments of the invention. It is understood that the following examples are provided to further illustrate the invention. They do not in anyway limit the scope of the present invention.

### EXAMPLE NOS. 1-3

For Example Nos. 1-3, a standard polyurethane carpet backing formulation was used. The aqueous polyurethane dispersions were frothed with compressed air. Comparative Example No. I was prepared with a sodium-based surfactant (disodium N-octadecylsulfosuccinimate) as the frothing aid. Example Nos. 2 and 3 were prepared with a frothing aid according to the present invention. To facilitate processing, one part per hundred resin (pphr) of a defoamer was added to the formulations of Example Nos. 2 and 3.

The finished carpets were analyzed according to industry conditions. The results are reported in Table 1. The data indicates that the frothing aid of the present invention facilitates lower coating weights. Moreover, the data indicates improved processing because the formation of blisters is prevented.

TABLE 1

| | Compound | Coat Weight | Hand (lb.) | Delamination | Tuft Bind | |
|---|---|---|---|---|---|---|
| Example | Solids, % | (oz/yd) (g/cm) | (kg) | (lb./in) (kg/cm) | (lb.) (kg) | Blister |
| 1 | 79.2 | 45 (13.95) | 12 (5.4) | 10.3 (1.84) | 14.6 (6.61) | Yes |
| 2 | 78.8 | 26.3 (8.15) | 12.4 (5.6) | 7.2 (1.29) | 11.7 (5.30) | No |
| 3 | 79.2 | 34.3 (10.63) | 16.1 (7.3) | 6.1 (1.09) | 14.6 (6.61) | No |

### EXAMPLE NOS. 4-12

For Example Nos. 4-12, another standard polyurethane carpet backing formulation was used. The aqueous polyurethane dispersions were frothed with compressed air. Comparative Example Nos. 4 and 5 were prepared with a sodium-based surfactant (disodium N-octadecylsulfosuccinimate) as the frothing aid. Example Nos. 6-12 were prepared with a frothing aid according to the present invention. To facilitate processing, about one part per hundred resin (pphr) of a defoamer was added to the formulations of Example Nos. 6-12.

The finished carpets were analyzed according to industry conditions. The of selected analyses are reported in Table 2. The data indicates improved processing because the formation of blisters is prevented.

TABLE 2

| | Compound | Coat Weight | Hand (lb.) | Delamination | Tuft Bind | |
|---|---|---|---|---|---|---|
| Ex. | Solids. % | (oz/yd) (g/cm) | (kg) | (lb./in) (kg/cm) | (lb.) (kg) | Blister |
| 4 | 79.2 | 43.3 (13.42) | 14.7 (6.7) | 6.3 (1.12) | 15.9 (7.2) | Yes |
| 5 | 79.2 | 52.5 (16.28) | 23.8 (10.8) | 11.1 (1.98) | 15.7 (7.1) | Yes |
| 6 | 78.8 | 30.5 (9.46) | 16.7 (7.6) | 6.5 (1.16) | 11.1 (5.0) | No |
| 7 | 79 | 32.7 (10.14) | 18.3 (8.3) | 3.8 (0.68) | 15.3 (6.9) | No |
| 8 | | 35.8 (11.10) | 19.9 (9.0) | 3.8 (0.68) | 15.7 (7.1) | No |
| 9 | | 31.2 (9.67) | 17.0 (7.7) | 4.3 (0.77) | 12.3 (5.6) | No |
| 10 | | 33.6 (10.42) | 16.5 (7.5) | 4.1 (0.73) | 15.3 (6.9) | No |
| 11 | 79.2 | 43.4 (13.46) | 20.7 (9.4) | 8.4 (1.50) | 20.4 (9.2) | No |
| 12 | | 36.0 (11.16) | 16.4 (7.4) | 4.8 (0.85) | 15.3 (6.9) | No |

What is claimed is:

1. An aqueous polyurethane dispersion comprising
a. a polyurethane dispersion composition and
b. a frothing aid prepared by mixing
i. a nonionic siloxane alkoxylate having the formula
R¹Me₂SiO[Me₂SiO]_{f}[MeSi(Q)O]_{g}SiMe₂R¹
wherein f=0 to 1;
g=1 to 2;
Q=C_{d}H_{2d}O(C₂H₄O)ₜ(C₃H₆O)_{W}(C₄H₈O)_{X}R²
wherein d=2 to 4;
t=3 to 12;
w=0 to 8,
x=0 to 8, providing when w or x>0,
(t+w+x)−5to 12;
R² is hydrogen, acetyl, or a hydrocarbon radical having 1 to 4 carbon atoms; and
R¹ is Q or an alkyl having 1 to 4 carbon atoms with
ii. an organic cosurfactant having the formula
R³O(C₂H₄O)ₐ(C₃H₆O)_{b}(C₄H₈O)_{c}R⁴
wherein R³ is an alkyl, alkenyl, aryl, or alkaryl having 8 to 16 carbon atoms;
a=2 to 12;
b=0 to 2;
c=0 to 2; and
R⁴ is hydrogen, acetyl. or a hydrocarbon radical having 1 to 4 carbon atoms,
with a molar ratio between 1:19 to 19:1.

2. The aqueous polyurethane dispersion of claim 1 wherein f=0, g=1, d=3, t=4 to 8, R¹ is methyl, R³ is alkyl having 8 to 12 carbon atoms, R² is H or Me, R⁴ is H, w=0,x=0,a=5to 8,b=0,and c=0.

3. The aqueous polyurethane dispersion of claim 2 wherein t=7 to 8, R³ is alkyl having 10 to 12 carbon atoms, and a=5.

4. The aqueous polyurethane dispersion of claim 1 wherein the molar ratio of the nonionic siloxane alkoxylate to the organic cosurfactant is between 5:1 to 1:5.

5. The aqueous polyurethane dispersion of claim 1 wherein the molar ratio of the nonionic siloxane alkoxylate to the organic cosurfactant is between 0.8:1 to 1.2:1.

6. The aqueous polyurethane dispersion of claim 1 wherein the water is a continuous phase.

7. An aqueous polyurethane dispersion comprising:
a. a polyurethane dispersion composition:
b. a nonionic siloxane alkoxylate having the formula
R¹Me₂SiO[Me₂SiO]_{f}[MeSi(Q)O]_{g}SiMe₂R¹
wherein f=0 to 1;
g=1 to 2;
Q=C_{d}H_{2d}O(C₂H₄O)ₜ(C₃H₆O)_{W}(C₄H₈O)_{X}R²
wherein d=2 to 4;
t=3 to 12;
w=0 to 8,
x=0 to 8, providing when w or x>0.
(t+w+x)=5 to 12;
R² is hydrogen, acetyl, or a hydrocarbon radical having 1 to 4 carbon atoms: and
R¹ is Q or an alkyl having 1 to 4 carbon atoms: and
c. an organic cosurfactant having the formula
R³O(C₂H₄O)ₐ(C₃H₆O)_{b}(C₄H₈O)_{c}R⁴
wherein R³ is an alkyl, alkenyl, aryl, or alkaryl having 8 to 16 carbon atoms;
a=2 to 12;
b=0 to 2;
c=0 to 2;and
R⁴ is hydrogen, acetyl, or a hydrocarbon radical having 1 to 4 carbon atoms.
with a molar ratio of the nonionic siloxane alkoxylate to the organic surfactant between 1:19 to 19: 1.

8. The aqueous polyurethane dispersion of claim 7 wherein the polyurethane dispersion composition (a) has a polyol as an active hydrogen compound.

9. The aqueous polyurethane dispersion of claim 8 wherein f=0, g=1, d=3, t=4 to 8, R¹ is methyl, R³ is alkyl having 8 to 10 carbon atoms, R²is H or Me, R⁴is H, w=0, x=0, a=5to 8,b=0.and c=0.

10. The aqueous polyurethane dispersion of claim 9 wherein t=7 to 8, R³ is alkyl having 10 to 12 carbon atoms, and a=5.

11. The aqueous polyurethane dispersion of claim 8 wherein the molar ratio of the nonionic siloxane alkoxylate to the organic cosurfactant is between 5:1 to 1:5.

12. The aqueous polyurethane dispersion of claim 8 wherein the molar ratio for the nonionic siloxane alkoxylate to the organic cosurfactant is between 0.8:1 to 1.2:1.

13. A method for applying an aqueous polyurethane dispersion to a substrate comprising:
a. forming an aqueous polyurethane dispersion by mixing
a polyurethane dispersion composition;
ii. a nonionic siloxane alkoxylate having the formula
R¹Me₂SiO[Me₂SiO]_{f}[MeSi(Q)O]_{g}SiMe₂R¹
wherein f=0 to 1;
g=1 to 2;
Q=C_{d}H_{2d}O(C₂H₄O)ₜ(C₃H₆O)_{W}(C₄H₈O)_{X}R²
wherein d=2 to 4;
t=3 to 12;
w=0 to 8,
x=0 to 8, providing when w or x>0,
(t+w+x)=5 to 12;
R² is hydrogen, acetyl, or a hydrocarbon radical having 1 to 4 carbon atoms; and
R¹ is Q or an alkyl having 1 to 4 carbon atoms; and
iii. an organic cosurfactant having the formula
R³O(C₂H₄O)ₐ(C₃H₆O)_{b}(C₄H₈O)_{c}R⁴
wherein R³ is an alkyl, alkenyl, aryl, or alkaryl having 8 to 16 carbon atoms;
a=2 to 12;
b=0 to 2;
c=0 to 2; and
R⁴ is hydrogen, acetyl, or a hydrocarbon radical having 1 to 4 carbon atoms,
with a molar ratio of the nonionic siloxane alkoxylate to the organic surfactant between 1:19 to 19:1;
b. frothing the aqueous polyurethane dispersion; and
c. applying the frothed aqueous polyurethane dispersion to a substrate.

14. The method of claim 13 wherein the substrate is carpet.

15. A polyurethane-backed carpet prepared in accordance with claim 14.

16. The polyurethane-backed carpet of claim 15 wherein the frothed aqueous polyurethane dispersion is applied as a carpet layer selected from the group consisting of a precoat, a laminate layer, and a foam layer.
